(19) United States
(12) Patent Application Publication
(10) Pub. No.: US 2002/0002475 A1
(43) Pub. Date: Jan. 3, 2002

(54) Automated insurance system and method

(76) Inventors: Joel Freedman, Redendo Beach, CA (US); Pamela Veitzer, Santa Monica, CA (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/833,074

(22) Filed: Apr. 12, 2001

Related U.S. Application Data
(60) Provisional application No. 60/196,928, filed on Apr. 13, 2000.

(51) Int. Cl. G06F 17/60

(52) U.S. Cl. 705/4

(57) ABSTRACT

An automated insurance system and method for enabling a Company to provide efficient, fully-integrated insurance coverage and related features. By taking full advantage of highly advanced digital video, data management, and online technologies, the Company's operating system can reduce the substantial number of employees found at most insurance companies today to a streamlined staff of executives, specialists, and support personnel. Aligned Providers preferably handle the primary functions of claims; most financial controls are preferably managed by integrating the information technology system and the Bank Lock Box; and the effectiveness of policyholder relations activities can be enhanced and related costs reduced through the capabilities of a specialized web portal. An associated fraud prevention system, claims management system, financial management system and information technology platform aspects of the invention can be used together to produce significant efficiencies and cost savings over current systems and methods.

### RELATED APPLICATIONS

This application claims the benefit of U.S. Provisional Application No. 60/196,928, entitled Automated Insurance System and Method, filed on Apr. 13, 2000.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to a system and method for automatically providing insurance to customers. More specifically, the present invention relates to a system and method for using the Internet to facilitate the management of insurance accounts, claims, underwriting, marketing, and associated functions.

2. Description of Related Art

The national personal auto insurance market was estimated at more than $120 billion in premiums in 1998. Personal auto coverage is considered one of the most competitive product lines in the insurance industry. There has been only minor innovation in this major market segment in recent years, and most basic auto insurance policies are hard to differentiate. As a result, there is little customer loyalty in the auto insurance business, and price has become the most significant factor influencing purchasing decisions by consumers, which has led to a period of falling premiums and slowing growth.

In response to the intense competition driving the market, the largest auto insurers are dramatically increasing their marketing efforts, expanding their distribution systems, raising levels of compensation paid to agents, and consolidating in an effort to protect their market share. Major auto insurers are also increasing their focus on effective underwriting and claims management in response to the rising costs of attracting and retaining policyholders.

Within this competitive environment, insurers are facing an even more challenging threat—insurance fraud. Auto insurance fraud is the largest and fastest growing segment of insurance fraud, and clearly one of the auto insurance industry's greatest obstacles. It is also largely responsible for a tense relationship between many insurers and the public. According to the National Auto Theft Bureau, approximately 15% of all vehicle theft reports are fraudulent, with the cost of all fraudulent claims accounting for 15 to 20% of total auto insurance premiums.

Insurance reform has moved into the limelight in many states, with California taking the lead in promulgating significant reform. An uncertain regulatory environment that can affect their ability to underwrite risks they may not be able to cover now confronts insurers. Solvency issues and rate regulation represent the primary concerns of the new regulatory efforts. Consumer groups have initiated an effective and unified strategy to keep insurance a popular topic, and there is a wide base of consumer demand for cuts in premiums.

For these reasons, a need has been recognized by the inventors for an improved system and method for providing insurance, and in particular, auto insurance, employing state of the art technology to achieve significant efficiencies and cost savings over conventional systems and methods, thus, providing more affordable insurance coverage.

### SUMMARY OF THE INVENTION

The present invention relates generally to a system and method for automatically providing insurance to customers. More specifically, the present invention relates to a system and method for using the Internet to facilitate the management of insurance accounts, claims, underwriting, marketing, and associated functions. The present invention solves the problems with, and overcomes the disadvantages of, conventional insurance coverage systems and methods.

The invention capitalizes on the proprietary integration of innovative automobile insurance products and leading-edge information technologies. The invention is a truly unique insurance program that positions any company practicing the invention (“the Company”) to become a fully cost-contained automobile insurance company, allowing the Company to offer the most consumer-oriented, value-driven automobile insurance products in the marketplace. As described herein, the Company may be a single entity, or the Company may represent a network, partnership or other organization of multiple entities conducting business together to implement the present invention.

At its core, the invention functions as a managed care system for automobiles, using networked repair facilities as a means of reducing policyholder premiums. The Company may offer full coverage policies that include liability, comprehensive/collision, uninsured motorist, bodily injury, towing, and other related coverage. In addition, the Company may offer standalone physical damage policies (i.e., comprehensive/collision) that may be attached to or combined with other insurance policies in the marketplace.

In a preferred embodiment, a company practicing the invention establishes relationships with reputable automobile repair companies (“Aligned Providers”) to provide their repair services to policyholders at reduced rates. The Aligned Providers handle much of the vehicle maintenance responsibilities from initial inspection to warranted repair to the collection of deductibles. The Company's relationships with its Aligned Providers should facilitate a significant reduction in direct claims expenditures.

In addition to the savings offered by the use of Aligned Providers, the invention incorporates many novel, but substantive cost-containment features. The innovative and efficient use of technology is a primary focus of the invention, enabling the Company practicing the invention to make its products and services more responsive and cost effective, its operation highly efficient, and its claims management, fraud prevention, and financial management systems the most effective in the industry. The invention preferably takes full advantage of emerging technologies such as XML-based Extranets, digital video/audio streaming, data mining, integrated multiple touch point Customer Relationship Management (“CRM”) system, etc.

As established insurers face a challenge integrating new technology into their cumbersome legacy systems, the invention's infrastructure and operating system take full advantage of state-of-the-art internet, digital video, and data management technologies to streamline a highly complex and data intensive business. The invention's IT system is linked to one or more web portals whose combined functionality supports several operating functions; provides an array of value-added benefits for policyholders, Agents/Brokers, Aligned Providers, strategic partners, and reinsurers; and offers a compelling internet environment for general consumers.

The invention's sophisticated IT system includes claims management and fraud prevention systems. Among other system procedures, Aligned Provider service attendants capture full motion digital videos of policyholder vehicles during initial inspections (including close-ups of any prior damage, and voice commentary). At the time of a claim, Aligned Providers access the web portal, input a password, and review initial inspection video and voice data to assure that no pre-existing damage is included in the preparation of estimates. Subsequently, Aligned Providers take full motion digital videos of damaged vehicles (and provide voice commentary), electronically submit the new video and voice data to Company adjusters, and input additional claims information into a series of web forms including all of the necessary data to complete a repair estimate. The claims management and fraud prevention systems:

Help control fraud by preventing estimates for damage incurred prior to the claims;

Enhance policyholder satisfaction by expediting the claims approval process; and

Dramatically reduce the costs associated with adjusting claims (video-enabled adjusters will be able to service up to ten or more claims per day, whereas traditional field adjusters typically service up to four per day).

Auto insurance fraud currently accounts for 15 to 20% of auto insurance premiums in the United States. The ability to significantly reduce this staggering cost factor is a major competitive advantage for a company practicing the invention.

The invention includes a financial management system to coordinate the processing of all accounting functions through the application of custom software and seamless integration with a Bank Lock Box facility. All payments made to a company practicing the invention are made to or deposited into a central Bank Lock Box account, and are electronically transferred into appropriate accounts (e.g., unearned premium reserve, claims reserve, working capital). This process may include an AutoReserve system, whereby an appropriate percentage of all annualized premiums is electronically transferred into an assigned reserve account upon receipt of policyholders' initial down payments. The financial management system is unique to the industry, and is expected to vastly reduce the amount of personnel typically required to administer accounting and billing/collection functions. It will effectively provide a running audit, including the status of the various accounts on a 24 hour-a-day, 7 days-a-week basis.

The invention provides numerous competitive advantages, including:

Policyholder premiums are reduced when compared to policies offered by other profitable insurers;

claims are processed in the most expeditious manner possible by high quality auto repair providers; and

Fraud and other policyholder improprieties are reduced, thereby protecting “honest” policyholders from unfair premium increases.

In a preferred embodiment of the invention, the web portal presents a highly appealing, graphically rich, user-friendly online environment offering policyholders and general consumers easy access to a wide range of products, services, features, and content offered by the Company, its strategic partners, and other credentialed parties. The web portal employs a unique interface to significantly differentiate it from other websites, and to create multiple revenue opportunities.

The invention may first be introduced, for example, in the Southern California marketplace (which represents the largest automobile insurance market in the U.S.). Subsequently, the Company may expand its market presence to include other markets/states, and enter into agreements with major national insurers to integrate a physical damage program; unparalleled claims management, fraud prevention, and/or financial management systems; and proprietary software modules into their existing automobile insurance programs.

The excessive profit margins built into outside repair shops' pricing, the costs related to legal disputes between repair facilities and insurers, and the immense volume of fraud in automobile insurance programs have priced automobile insurance coverage virtually out of the reach of the average working person. The invention's management controls and operating system help to negate unnecessary charges for “phantom repairs,” mitigate legal expenditures, control fraud and excessive claims, and reduce the 35+ percent repair facility profit margins. As a result, a company practicing the invention is able to offer insurance consumers lower premiums with an increase in the quality and efficacy of service.

By offering the most consumer-oriented, value-driven automobile insurance products in the industry, and by fully leveraging its highly efficient operating system and smart technology, the invention serves to transform the auto insurance business and establish the Company's operating platform as an industry model. Through maintaining a strong consumer orientation, and continually refining, improving, and updating technology, the invention would steadily increase a policyholder base.

### BRIEF DESCRIPTION OF THE DRAWINGS

FIG. 1 shows an exemplary claims method of the present invention;

FIG. 2A shows an exemplary Lock Box cash flow of the present invention;

FIG. 2B shows an exemplary Lock Box method of the present invention; and

FIG. 3 shows an exemplary system of the present invention.

### DETAILED DESCRIPTION OF THE PREFERRED EMBODIMENTS

The present invention will be described with reference to a company practicing the invention (“the Company”). As discussed above, the Company as described herein may be a single entity, or the Company may represent a network, partnership or other organization of multiple entities conducting business together to implement the present invention. Preferably, entities practicing the present invention are enabled for communication over a network.

At the outset of operations, the Company may offer full coverage policies that include liability, comprehensive/collision, uninsured motorist, personal injury, towing, and related coverage. In addition, the Company may offer standalone physical damage policies (i.e., comprehensive/collision) that may be attached to or integrated with other insurance policies in the marketplace. Depending on market entry conditions, the Company may offer services through parallel markets. In one embodiment, features of the present invention are offered through the rapidly-evolving Employee Benefits market, in which employers are aggressively seeking new ways to reward, recruit, and retain employees. These trends are leading to the introduction of new “voluntary” benefits, such as auto and homeowners insurance. Channel conflicts, system inadequacies, cumbersome paperwork-intensive processes, and underwriting and administrative systems that are not designed to support group submissions and billings have prevented most legacy auto insurers from successfully penetrating this vast market. However, the Company may navigate around its larger competitors by customizing its products and infrastructure for employers and their employees (e.g., accepting premium payments in the form of payroll deductions).

Leveraging the significant savings inherent in the invention's claims management and fraud prevention program, higher risk “non-standard” drivers that currently are priced out of the market, fall into the assigned risk pool, or would otherwise be uninsurable, could be accepted. The Company could simultaneously accept and offer a premium rate reduction to good risk drivers. Premium rates for these drivers would be based upon comparable current rates for like cars and drivers but with a rate reduction based upon the savings the Company derives on repairs from its use of Aligned Providers and other cost-containment features inherent in the invention.

Aligned Provider Network

The invention includes an Aligned Provider Network of credentialed repair facilities as a means of reducing policyholder premiums. The Company may establish a network of reputable repair companies to provide their repair services to policyholders at reduced rates. These Aligned Providers will preferably handle much of the vehicle maintenance responsibilities, from initial inspections to warranted repairs to the collection of deductibles.

The Aligned Providers will preferably be required to warrant their workmanship and maintain their own indemnity coverage. Aligned Providers may also allow policyholders to purchase their repairs, parts, accessories, and services not related to claims (e.g., tune-ups) at discounted rates. The Company may also institute credentialing and incentive programs to ensure that repairs are of the highest quality.

The profit margins built into outside repair shops' pricing, the costs related to legal disputes between repair facilities and insurers, and the immense volume of fraud in automobile insurance programs has virtually priced automobile insurance coverage out of the reach of the average working person. The invention's management controls and operating systems will help the Company to prevent unnecessary charges for “phantom repairs,” mitigate legal expenditures, and control fraud and excessive claims.

Automobile Physical Damage Policy

In one embodiment, the invention could enable the Company to offer physical damage policies or management services to individuals, businesses, employees, self insurers, and other insurance companies, among others. In addition, the Company practicing the invention could allow its Agents/Brokers to use the policies in conjunction with any standard products for automobile liability, personal injury, uninsured motorist, and/or other related types of coverage.

Physical damage coverage may apply to all permanently installed equipment, parts, or accessories that were purchased as standard or optional equipment from, and installed by, certified repair facilities and manufacturers. The Company will generally pay only for the amount of each loss or total loss to a policyholder's vehicle provided that the amount of each such loss is in excess of the deductible. The deductible could be paid by the policyholder directly to the Company, or if instructed by the Company, to an Aligned Provider.

Preferably, if the Company is obligated by its insurance policy to settle a loss and the policyholder chooses to have the loss repaired by a repair facility that is not an Aligned Provider, the policyholder will pay a sum equal to his/her deductible to the Company, and the Company will pay, for example, 80% of the reasonable and customary charges to repair or replace the policyholder's vehicle with a vehicle of like kind and quality. The Company may also make payment jointly to the policyholder and/or the chosen service facility.

Self Repair Option

In another aspect of the invention, a company practicing the invention offers another unique alternative to policyholders, the Self Repair Option. In the event of a loss covered under the physical damage policy, the policyholder may choose to have the applicable repairs performed by an Aligned Provider and pay for 100% of the total cost of those repairs, at the Company's agreed upon rates and terms. If the policyholder chooses to do so, the Company will not treat that loss as a claim, so the loss will have no effect on the policyholder's policy rating at the time of that particular loss or at the time of the policy's renewal. This effectively provides the Company's policyholders with a “self-insurance” benefit. Under this option, the Company will preferably still require that Aligned Providers take full-motion digital videos (with voice commentary) of the vehicles both prior to and following the repairs. This will allow the Company to document the changes/impairment to policyholder vehicles for future fraud prevention.

The Self Repair Option is an effective tool for enhancing cost containment by providing savings through not having to expend resources in dealing with small claims. The option also allows a company practicing the invention to document the changes/impairment to the insureds' vehicles for future fraud prevention and cost-containment controls.

There is a significant benefit to the policyholder in having the self-insurance option because, by virtue of being insured by the Company, the policyholder is eligible to take advantage of the Company's preferred rates from Aligned Providers, which are lower than standard repair costs. Policyholders may take advantage of these lower rates regardless of whether the policyholder or the Company pays for the repairs. Additionally, the Self Repair Option benefits policyholders by providing savings that can potentially exceed the amount of the loss incurred since, in the preferred embodiment of the invention, the Company will not remove policyholders' renewal discount benefits or increase the policyholders' premium rates, as would happen under standard insurance company methods. For example, in one embodiment, with the exception of ‘at fault’ accidents, self-insured losses have no effect on the Company's rating of the policyholders' policies at the time of the losses or at the time the policies are renewed.

Other Unique Benefits

In another aspect of the invention, Aligned Providers may be required to warrant their workmanship for a reasonable period of time and to carry and maintain their own indemnity coverage. This ensures that the repairs of the Aligned Providers will be of the highest quality, even after taking into account the negotiated discounts. In a preferred embodiment of the invention, Aligned Providers allow policyholders to use the Aligned Providers' products and services at discounted rates at any time while their policy is in effect. This benefit essentially provides policyholders with membership/network benefits at no additional cost.

Automobile Physical Damage Rates

By combining cost containment with a high degree of internal efficiency, the invention offers substantially reduced premium rates for physical damage coverage that could increase profitability above that of existing insurers currently paying standard reimbursement rates to third-party repair facilities.

Full Coverage Policy

A Company practicing the invention could offer full coverage policy may be offered that includes liability, comprehensive/collision, uninsured motorist, personal injury, towing, and related coverage. Initially, the full coverage policy may be priced on a comparable basis to those rates offered by other carriers providing similar coverage, but with a discount for the physical damage component. As the invention's cost-containment features take effect, substantially lower rates for full coverage policies should be sustainable. The Company may further use reinsurance agreements or joint-venture arrangements with rated insurers to share insurance risks and control exposure to large losses. For example, the Company may reinsure a portion or all of the risks associated with a non-physical damage component of its full coverage policies.

Sales and Marketing Overview

It is well documented that a large percentage of policyholders select their personal automobile insurance policy primarily on the basis of price. As a result, a large market exists for an auto insurance company capable of providing higher quality products and better services at lower prices. By offering superior products and services, a company practicing the invention can generate a significant base of policyholders.

The Employee Benefit Market

The Employee Benefits market has begun to change dramatically in recent years. As the US employment market has become more competitive, employers have found it increasingly difficult to reward, recruit, and retain employees. As a result, companies are looking for ways to differentiate themselves and are integrating different forms of compensation, benefit programs, and other non-traditional considerations (e.g., family/life needs) to directly improve and increase employee satisfaction and retention. These trends are facilitating the introduction of new “voluntary” products, such as auto and homeowners' insurance, which are becoming popular as employers attempt to tailor ancillary benefits to the needs of their employees.

Many existing auto insurers face numerous challenges in pursuing the Employee Benefits market. Channel conflicts, system inadequacies, cumbersome paperwork-intensive processes, and underwriting and administrative systems that are not designed to support group submissions and billings have hampered these carriers from successfully penetrating this vast market. With an operating system ideally suited to address the needs of employers and their employees, a Company practicing the invention has an opportunity to establish a leadership position in this substantial market.

To serve the maximum number of qualified employees, a company practicing the invention could offer both standard and non-standard full coverage and standalone physical damage policies that provide considerable advantages when compared to other personal auto policies. The policies could be priced on a highly competitive, actuarially sound basis, and offer an array of value-added benefits.

A recently released survey conducted for Metropolitan Life suggest that approximately 66% of employees believe voluntary benefits are a good idea, citing value and convenience as the primary reasons. In accordance with the present invention, products and services of a Company practicing the invention are uniquely suited to address these demands.

Applying the invention, the Company could offer an Employer Sponsored Auto Insurance Program that could be positioned as a voluntary insurance program designed to help employees get more out of their auto insurance. Both full coverage and standalone physical damage policies are preferably available. The policies could offer numerous benefits, such as:

Special Group Rates. The Company's already discounted rates could be further reduced for employees/members whose employers/groups sponsor the program. Preferably, these rates would not be available to individual policyholders.

Value Added Benefits. In addition to lower premiums, policyholders preferably receive a wide range of attractive value-added benefits that are included at no additional cost with policies, such as discounts on repairs, parts, accessories, and services not related to claims; automobile buying and selling services; and a bona fide ‘Self Insurance’ benefit for individuals.

Broad Underwriting Selection. The invention's multi-tiered pricing structure allows the Company to underwrite virtually any individual auto risk, allowing the Company to offer a policy to virtually all employees.

Convenient Payment Options. In one embodiment, the invention's financial management system can handle various payment methods, including payroll deductions, automatic deductions from personal checking accounts, or traditional home billing. With payroll and automatic deductions, premium payments could be divided evenly throughout the policy term, so that no hefty down payment would be required when signing up, and so there would be no need to remember payment due dates, receive bills in the mail, or write checks to pay premiums.

Easy Access. Employees can easily obtain policy information and real-time quotes through the web portal, strategic partner web sites, and/or Employer Sponsor extranets, as well as through the web sites of select Agents/Brokers, Aligned Providers, and other strategic marketing partners.

Real-time Support. When policyholders log on the web portal, they could be given access to a range of services and information about their accounts, including the types of coverage in effect, billing data, status of active claims, and 24-hour claims reporting and policyholder relations systems.

Extended Service Hours. In addition to the numerous services available online, a toll-free, 24-hour telephone number could be provided for all of the employees' insurance needs, so policyholders can take care of their insurance matters when it's most convenient.

In addition to the many benefits available to employees, the invention preferably offers a range of data mining and reporting tools that could be made available to Employer Sponsors to simplify their administration of the Company's program. The Company's financial management system is uniquely capable of providing a wide range of customized reports in real-time.

The efficiencies brought by the use of the invention in worksite enrollments preferably reduce underwriting time and expense, facilitate policy issuance and initial administrative processes, and make the presentation of the products more personal, interactive, and understandable to Employer Sponsors and their employees.

Other Strategic Marketing Alliances

A Company practicing the invention could establish strategic marketing alliances with various companies that have strong influence in the Company's target markets. The Company could offer its strategic marketing partners the opportunity to add a valuable component to the products and services they already provide to their existing customers. In return, these strategic marketing partners could provide the Company with direct access to prospective policyholders on a credible and cost effective basis.

Some of the additional benefits for strategic partners include:

Offering consumer-oriented, value-driven group auto policies that are customized to meet the needs of diverse customer bases;

Generating referral fees through their in-house sales forces (e.g., telemarketing, inserts in billing statements) and Web-based distribution (e.g., promoting the Company's products on their web sites);

The ability to promote its products and services through alternative distribution channels developed by the Company; and

For other insurers, reducing acquisition costs on business generated through Agents/Brokers by negotiating reduced commissions in consideration of the Agents'/Brokers' abilities to generate commissions from two or more complementary products, as opposed to one.

The invention's highly scalable and flexible infrastructure and operating systems are preferably uniquely suited to support and serve both corporate and individual customers across the country. As a result, the Company's web interface, financial reporting systems, underwriting guidelines, claims procedures, marketing and sales policies, and policyholder relations initiatives could be customized to support the needs of strategic partners, their customers, and their distribution affiliates.

A Company practicing the invention could build strategic marketing alliances in the following areas:

Automobile Dealerships and Finance Companies

Dealerships and finance companies often lose sales because, although their customers may qualify for financing, they either cannot afford to insure their vehicles, or they do not qualify for the types of coverage they need. By having an affordable alternative to traditional auto insurance coverage available at the time of purchase, and an alternative that accepts virtually all drivers, the automobile dealerships/finance companies will have opportunities to increase their sales volumes, and the Company will have opportunities to increase its policyholder base on a cost-effective and relatively passive basis.

Depository Institutions

Banks and other depository institutions have found that many customers are interested in one-stop financial service operations. According to the Association for Banks-in-Insurance, more than 2,000 US banks now offer insurance products, including virtually all of the largest institutions. In 1998, premium revenues generated by banks grew by roughly 35% over the prior year. In 1999, banks and thrifts purchased 63 insurance agencies, up from 44 in 1998, according to SNL Securities. However, bank distribution of insurance products remains a largely untapped opportunity. For example, Wells Fargo, which presently has the largest agency force among the major banking institutions, had sold insurance policies to just 2% of its bank customers as of 1999.

Given the uniqueness of the invention, as well as the integration with a Bank Lock Box facility, the Company could offer its products and services through the commercial banking community, which is an efficient and cost-effective way for the Company to increase its policyholder base.

Aligned Providers

Aligned Providers have their own existing client relationships with numerous customers who have confidence in the Aligned Providers' repair services. Many of these customers would use the Aligned Providers' repair services even if they were not policyholders of the Company or subject to the invention's two-tier deductible system.

A Company practicing the invention could leverage such relationships by implementing a unique marketing program that is unlike the programs of any other insurers. Preferably, selected Aligned Providers will appoint one or more individuals to become licensed agents for the Company, which could allow the Aligned Providers to augment their revenue base through earning ongoing agency commissions or referral fees by representing the Company's products and services to existing customers.

The Company could conduct a direct mail campaign to the Aligned Providers' existing client base, and then have Aligned Provider Agents follow up with personal contact at the facilities, by telephone, or by directing the clients to the web portal. The Company could also allow selected Aligned Providers to actively promote their own products and services through inserts in the Company's billing statements and direct mail promotions, and through web pages, links, and banners on the web portal. This will strengthen policyholders' perception of the Company's “partnership” with its Aligned Providers, and at the same time offer increased marketing exposure to Aligned Providers at little or no cost.

Self Insurers

Physical damage and fraud prevention management services in accordance with the invention may also be provided to: (1) companies that self-insure and need claims management; (2) risk managers at other insurance companies; and (3) safety directors who want to keep insurance costs down for their organization, among others. By maintaining an automated loss analysis and online financial, claims, and fraud prevention management systems, a Company practicing the invention can be better positioned to cover the self-insured market.

Other Insurance Companies

Aspects of the present invention may be incorporated into a complete automobile insurance package offered by existing insurers. These insurers could then market their upgraded insurance package to their existing policyholders.

Direct Sales

A Company practicing the invention could establish a Managing General Agency (“MGA”) or general agency that can write policies directly or through referrals from Strategic Partners, Employer Sponsors, and/or Agents/Brokers. In one embodiment of the invention, the MGA works with the Company's Policyholder Relations Division to function as a core in-house marketing team responsible for implementing all direct marketing activities, managing a network of external Agents/Brokers, and building relationships with and managing a network of strategic marketing partners and Employer Sponsors.

The invention's Web-enabled Relationship Management System preferably enables employees and other prospects to easily obtain policy information and real-time quotes through multiple portal-based touch points such as the web portal, the web sites of strategic partners, and Employer Sponsor extranets, as well as through the web sites of select Agents/Brokers, Aligned Providers, and other strategic marketing partners. The web portal may offer a unique feature through the availability of one or more ‘virtual agents’ that can address numerous questions online in real time, collect application and claims information, facilitate quotes, and help prospective customers make purchasing decisions. Product information and quotes will also be available by calling a toll-free, 24-hour number and interacting with the Company's Voice Computer Interface or speaking with Company personnel.

With the help of the invention, the Company could achieve superior levels of policyholder retention. For example, the invention's financial management system could electronically generate and distribute renewal notices to policyholders by e-mail and regular mail (or as directed by Employer Sponsors) 30 days before their policies expire. If policyholders fail to respond, they could be sent reminder notices 15 days prior to their cancellation dates. Agents/Brokers or Policyholder Relations personnel could personally contact policyholders one week prior to the termination of policies, and perhaps within the one to two weeks following termination.

In one embodiment of the invention, a constantly-updated database of policyholder and web site visitor profiles could be maintained, which would enable the Company to adapt and respond rapidly to the demands and desires of its most valuable Commodity—its customers. The invention could automatically generate periodic requests for information updates to keep all policyholder and visitor files current. This information can be requested automatically when policyholders or visitors/members log in to the web portal, as well as through request forms sent by e-mail and regular mail.

Information in the database could allow the Company to customize many of its public relations and marketing materials, and enable the Company to provide a range of unique benefits, such as automatically sending a policy quote to family with a child nearing driving age that shows the rate for adding the child to the family's policy. The information could also allow the Company to automatically extend personalized social pleasantries, such as congratulations on anniversaries, birthdays, graduations, and other special occasions. By maintaining an open line of communication with policyholders and web site visitors, the Company is preferably able to build long-term relationships that can lead to sustainable growth and profitability.

Independent Insurance Agents/Brokers

In today's highly charged competitive environment, insurance Agents/Brokers can realize significant benefits by offering consumer-oriented, value-driven policies that are truly unique and beneficial. The present invention can help Agents/Brokers differentiate themselves from their competitors, improve customer retention, and attract new customers who would be difficult to reach otherwise.

A company practicing the present invention could establish a network of independent Agents/Brokers who will be offered a combination of marketing tools to enhance customer awareness of the Company's program and maximize sales performance. Agents/Brokers could also direct prospective customers to the web portal, which offers numerous capabilities such as answers to the most frequently asked questions, rate quotes in real-time, and help in making purchasing decisions. Agents/Brokers may receive competitive commission payments made directly by the Bank Lock Box facility, in accordance with that aspect of the invention, on an earned premium basis.

Operations Overview

Management

The Company's management can make full use of the invention's leading-edge information system to exercise full underwriting control; issue policies; collect premiums; perform accounting, actuarial, safety, and loss control services; adjust and pay losses and claims; maintain appropriate policyholder retention levels; administer the Company's technology platform; and develop a well-structured investment portfolio.

Underwriting

The underwriting profitability of most insurers is affected by many factors. These include price competition, the cost and availability of reinsurance, administrative and other expenses, natural disasters, claims trends, legislative/regulatory actions and initiatives, and fraud, among others. Trends in loss frequency and severity are also influenced by numerous economic factors such as inflation rates, employment levels, crime rates, general business conditions, etc. Legislative, judicial, and regulatory measures further define and expand the risks and damages covered by insurance. The diversity of insurers' policyholder bases can also affect their underwriting profitability.

The invention's financial management system will preferably support the company's underwriting division by maintaining digital underwriting profiles of policyholders and other drivers, in order to accurately and fairly calculate the risk of insuring the properly identified vehicles. The financial management system can maintain comprehensive data files that include coverage information, unacceptable risks, policy issuance procedures, rating procedures, and general underwriting rules, in order to instantaneously and accurately calculate quotes.

In one embodiment of the invention, by accessing the web portal, Agents/Brokers and other channel partners are able to review the Company's general underwriting rules and guidelines, including an electronic rate guide defining territorial limits, classes of automobile users, driver discounts and surcharges, automobile body types, policyholder rating codes, geographic operating zones for Aligned Provider coverage, and other relevant information. A visual, informative, and interactive Web-based training program that outlines the merits and processes of the invention's system and methods of operations could also be available.

When writing policies, Agents/Brokers and/or prospective policyholders preferably complete online forms designed to collect all of the data necessary to process insurance applications. The financial management system can then automatically calculate non-binding quotes, which can be made available instantaneously to Agents/Brokers and prospective policyholders through the web portal. Concurrently, the financial management system will preferably organize the data from the online forms into digital applicant files, and alert the Company's underwriting division that there are active applicant files requiring attention.

When marketing through Employer Sponsors, the invention enables employees and/or human resources personnel to easily submit applications through multiple touch points, including a registration interface found at the web portal, the web sites of strategic partners, and Employer Sponsor extranets. When possible, submitted information could be correlated with strategic partner and/or Employer Sponsor data to insure its accuracy. Subsequently, the financial management system can organize the data from the online forms into digital applicant files, and alert the Underwriting Division that there are active applicant files requiring attention.

Preferably, upon receipt of the active applicant files, underwriters will review the data for accuracy and completeness, and the invention's Central Data Center will access various databases to verify driving records and identify “gray market” vehicles and vehicles previously reported as salvage or total losses. If the underwriters require more information, they can initiate phone calls with or remit electronic messages to Agents/Brokers or other appropriate parties to accelerate the process of approving and issuing policies.

Once all the necessary information is in hand, the Central Data Center will preferably calculate final quotes, and either schedule a time for Company personnel to conduct initial vehicle inspections at Employer Sponsor work sites or present a list with one or more convenient Aligned Provider locations. Once the initial inspections are performed, underwriters can verify the information contained in the applicant files, and issue binders. In certain Employer Sponsored situations, temporary binders could be issued prior to the completion of the initial inspections at non-discounted rates, with the discounts taking effect once the inspections are performed.

In the event of claims, the Underwriting Division will preferably review policyholder files to determine if any rate adjustments or cancellations are appropriate. Fraud may always be grounds for immediate cancellation.

Claims

The invention will preferably enable the Company to assure that all claims are properly processed and that all repair work on policyholder vehicles is of high quality and completed in a timely fashion. The Company can continually monitor claims performance, including the performance of Aligned Providers and Agents/Brokers, and the loss ratios associated with the Company's various product lines. The invention preferably enables the Company to minimize the lag between the filing of claims reports and claims being closed since the timely resolution of claims has a great impact on policyholder satisfaction.

In a preferred embodiment of the invention, once the Claims Division approves the claims, Aligned Providers commence repairs, and the Bank Lock Box electronically transfers the appropriate amounts to a claims reserve account, or statutory reserve account. Once the repairs are completed and the policyholders have accepted their vehicles (by logging into the web portal at the Aligned Provider locations, inputting their passwords, and verifying their acceptance of the vehicles, for example), the Bank Lock Box electronically transfers payment to the Aligned Providers' business accounts. Such prompt payment is a benefit to the Aligned Providers as a service provider, and an incentive to attract new Aligned Providers.

In one embodiment, to filly enable the online capabilities of its Aligned Providers, the Company will supply each Aligned Provider with a computer system consisting of:

A minimally configured high performance workstation,

A digital video camcorder, and

A high-speed secure Internet connection (i.e., DSL or cable modem).

Claims Processing

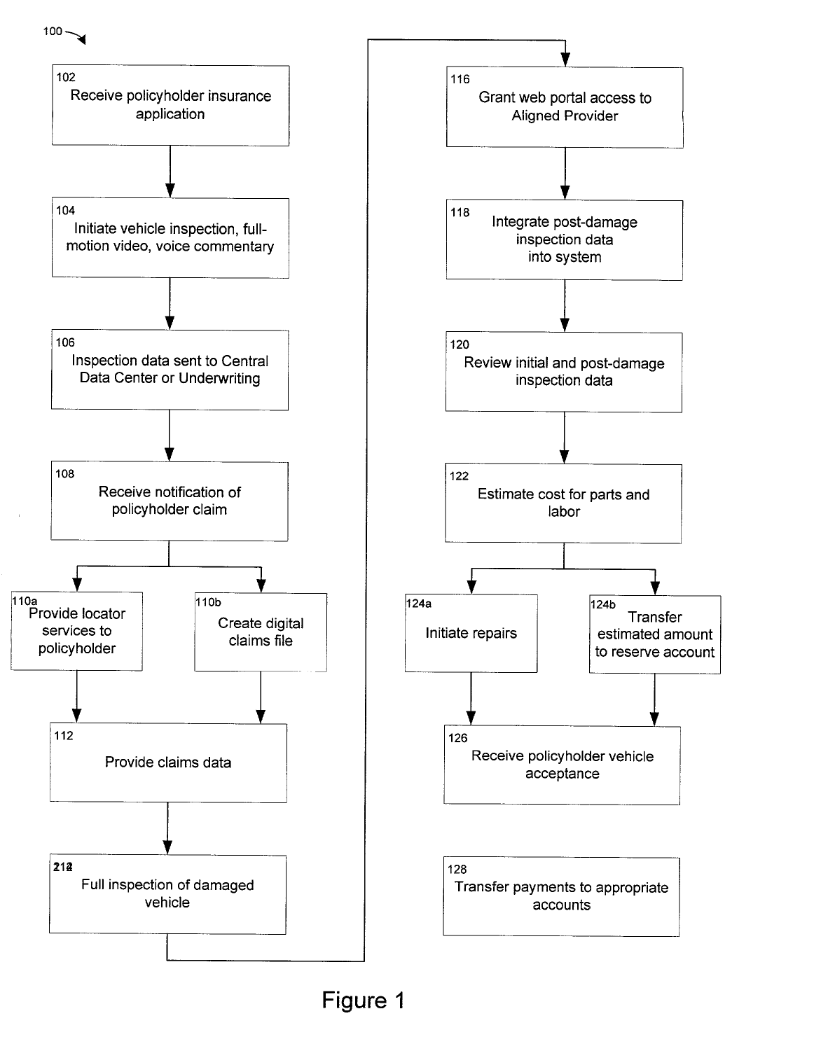

Referring to FIG. 1, an embodiment of a method for processing claims in accordance with the present invention is illustrated. The method 100 is provided by way of example only, and need not include all illustrated steps. The steps may occur in any order or concurrently. The steps may be performed by the Company, or may be performed by other entities at direction of the Company. Also, additional steps may be performed as desired as will be apparent to one skilled in the art.

In step 102, upon acceptance of policyholder applications (prior to issuing binders), policyholders have their vehicles professionally inspected by Company personnel or Aligned Providers. In step 104, the Company personnel or Aligned Providers perform analyses and take full-motion digital videos of the vehicles (including close-ups of any prior damage) with voice commentary. The video and commentary inspection data are then preferably transmitted to the Underwriting Department or Central Data Center, such as through the Company's web portal, preferably via a high-speed Internet connection, in step 106. Aligned Providers may input additional information into online forms accessed through the Company's web portal. The video, voice, and forms data may then be sorted and organized electronically into digital policyholder files, reviewed for accuracy and completeness by the Company's adjustment office, and permanently stored in the Company's Hierarchical Data Storage (HSM) system.

In the event of accidents or losses, policyholders in step 108 notify the Claims department, such as through the motor clubs or the Company's web portal, or by calling a toll-free Claims Hotline and using the Computer Voice Interface or speaking directly with Company personnel. In step 110a, the contact means selected by policyholders in step 108 will preferably electronically or personally direct policyholders to the most convenient Aligned Provider locations or have tow trucks dispatched. In a step that may be concurrent 110b, the Central Data Center preferably creates digital claim files, updates digital policyholder files, automatically notifies the Claims Departments that active claim files require attention, and notify Aligned Providers of the impending arrivals of damaged vehicles. In addition, the Company's HSM system preferably moves the applicable digital claims files into ‘priority status’ for rapid retrieval.

In this embodiment, once damaged vehicles arrive at the Aligned Provider locations, the Aligned Providers may access the Company's web portal, input passwords they have selected or been assigned by the Company, and view the data specific to the claims (including the video streams and comments captured during initial inspections) in step 112. Since numerous digital video streams or single frames can be instantaneously accessed via the Aligned Providers' high-speed secure network connections, the Aligned Providers will preferably have necessary access to digital policyholder files for every vehicle in their care. Thus, Aligned Providers may learn of any pre-existing damage prior to calculating repair estimates and initiating claims-related repairs.

In step 114, after reviewing the initial inspection data, the Aligned Providers preferably inspect the damaged vehicles, take full-motion digital videos of the vehicles, and provide voice commentary regarding the relevant damage. Aligned Providers may be instructed to perform this inspection by the Company. In step 116, the Aligned Providers may then access the Company's web portal, deliver the new video and voice data, and quickly complete a series of online forms that collect all of the necessary information required for their repair estimates. Next, the Central Data Center will preferably, in step 118, integrate the new digital data into appropriate digital claim files, update digital policyholder files, and let the claims Division that active claim filed require attention.

In this embodiment, upon receipt of the active claim files, the Company's claim adjusters review the video and voice data of both the initial and post-damage inspections of vehicles in, step 120, to immediately confirm the damage and make certain that no pre-existing damage was included in the repair estimates. They may also review the data submitted through online forms. If more information is required, phone calls or e-mail requests may be initiated. Alternatively, web request forms, which will significantly accelerate the process of approving repair estimates, may be used.

In step 122, the Central Data Center preferably will automatically calculate the most current prices for parts and labor based on the Company's agreements with the Aligned Providers. Once these claims are approved, the Aligned Providers may be instructed to commence repairs in step 124a. In a step that may be concurrent 124b, the Company's financial management system will preferably transfer the full amounts of the repair estimates (less deductibles or any required co-payments) to a claims reserve account. Once repairs are completed, policyholders preferably accept their vehicles in step 126 (and assign subrogation rights to the Company), such as through the online motor clubs or the Company's web portal. The financial management system then preferably electronically transfers payment to the appropriate accounts, such as the Aligned Providers' business accounts, in step 128.

The above method 100 may be practiced for any claims, but may be preferred for in-network claims. For out-of-network claims, a method for handling claims may include additional and/or alternative steps if desired. In one embodiment, the Claims Division will handle Out-of-Network claims in the following manner:

When policyholders have accidents or losses, they will notify the Company via the motor clubs, the Company's web portal, or by calling the Company's toll-free Claims Hotline. They will then drive their vehicles to Out-of-Network repair facilities, or the Company will arrange for tow trucks to be dispatched. The Company's Central Data Center will automatically create digital claim files, update digital policyholder files, and notify the Claims Division that active Claim files require attention. As soon as possible, the Claims Division will contact the Out-of-Network providers.

Out-of-Network providers with Internet access who are handling out-of-zone physical damage claims will be provided with a short-term password to log onto the Company's web portal and review data pertaining to the claims (including the video streams and voice commentary from initial inspections). Providers without Internet access will be faxed relevant claims information, along with forms to fax back to the Claims Division.

Out-of-Network providers handling either physical damage claims or liability claims may be sent video camcorders and other relevant claims information if the amounts of the claims justify the expense. The providers will be encouraged to take full-motion digital videos of the damaged vehicles (with voice commentary), send the camcorders and data back to the Claims Division, and input their estimates into online forms accessed through the Company's web portal. If they have no Internet access, providers can request to be faxed standard forms to submit to the Claims Division. Providers that work with the Company's system will benefit by receiving prompt payment through the Company's financial management system, once repairs are completed and policyholders accept their vehicles. Select providers may also be invited to join the Company's Aligned Provider Network.

If Out-of-Network providers are unable or unwilling to work with the Company's digital systems, the Company may deploy field adjusters with video camcorders and laptops with wireless Internet connections. The adjusters will take full-motion digital videos (with voice commentary) of damaged vehicles, transfer the video and voice data to the Claims Division via the Company's web portal, for example, and input additional information into the online forms. In-house adjusters will then assume the rest of the claims adjusting processes.

Once claims are approved, Out-of-Network providers will commence repairs, and the Bank Lock Box System will electronically transfer the full amounts of the estimates, less the amount of the deductibles or any required co-payments, to a claims reserve account, or statutory reserve account. The Claims Division must approve any work in excess of the original claim estimates. Once repairs are completed and policyholders accept their vehicles, the Bank Lock Box System will promptly release payments to the providers.

As discussed above, the present invention provides policies that include a bona fide “self-insurance” benefit for individuals. If policyholders elect to exercise their Self-Insurance Options, it is preferred that the Company still require that Aligned Providers take full-motion digital videos (with voice commentary) of the vehicles both prior to and following the repairs. This will allow the Company to document the changes/impairment to policyholder vehicles for future fraud prevention.

Policyholder Relations

Preferably, a Policyholder Relations Division may work with the Company's internal agents to implement the Company's marketing plan. This division will also work to properly address policyholder requests, concerns, suggestions, and complaints.

Any policyholder who does not understand the benefits of the Company's products or services, who would like to make a complaint, or who wants to change coverage or amend a policy may initially be directed to the web portal. A policyholder who does not have Internet access or whose issues remain unresolved may leave word through the Company's Voice Computer Interface, and a representative will personally contact the insured by telephone, for example, within two business days. With a goal of reducing the need for policyholders to contact their Agents/Brokers or the Company's Policyholder Relations division, a preferred embodiment of the invention allows policyholders automated 24-hour access to policy and other account information through the web portal, online motor clubs or by calling the Company's Policyholder Support Line and accessing the Voice Computer Interface. The interface will preferably integrate several leading-edge telephony applications, including a customized Touchtone Order Entry System, Interactive Voice Response System, Wireless Application Protocol, seamless integration with Company databases, and a voice-mail system enabled for storing messages for later retrieval by telephone or online through the Company's intranet. The Company's web portal may also provide access to policy and other Company information, although it may not include the non-insurance content and benefits offered by the online motor clubs.

When policyholders log into the web portal and/or online motor clubs and input their passwords, they are preferably given access to a range of services and information about their accounts, including the types of coverage in effect, billing data, status of active claims, and a claim reporting system that electronically notifies the adjustment office of accidents, and routes policyholders to the most convenient Aligned Provider locations (or dispatches tow trucks). As Internet-based video conferencing becomes more reliable, policyholders may be able to conduct real-time, interactive two-way videoconferences with their Agents/Brokers, Aligned Providers and/or the Company's Policyholder Relations division or other Company personnel.

The web portal facilitates ongoing communication with policyholders. Policyholders may receive periodic e-mail messages providing updates regarding their accounts or policies, highlights of products and services offered by Aligned Providers or strategic partners, special promotions, and ongoing information and education regarding the automobile and insurance industries, such as new product information, regulatory initiatives, and other valuable content. The present invention facilitates ongoing communication since, through its integration of the Company and affiliates with the Internet, the invention is capable of automatically keeping track of policyholders' circumstances which may make individual policyholders particularly receptive to specific types of information.

Communications may also be facilitated by providing one or more online motor clubs, as discussed above. When policyholders visit these motor clubs, they will preferably have password-protected real-time access to a range of services, including information about their accounts such as the types of coverage in effect, billing data, status of active claims. They can also report claims via an online claims reporting system that will automatically notify the Claims Division of accidents and route policyholders to the most convenient Aligned Provider locations or, if necessary, automatically have tow trucks dispatched. Policyholders may request further information by calling a toll-free number and accessing the Company's Voice Computer Interface. Policyholders may also log on to the Company's web portal, which further provides real-time access to information specifically related to the Company's insurance policies, but not the non-insurance content and benefits offered by the motor clubs in this embodiment.

Policyholders may also receive periodic e-mailed and mailed messages with updates regarding their accounts or policies (including notification if they are late in remitting their premium payments or subject to prospective cancellation by the Company), highlights of products and services offered by Aligned Providers and Strategic Partners, special promotions, and ongoing information related to the automobile and insurance industries, such as new product information, regulatory initiatives, and other valuable content.

In one embodiment, the Central Data Center will from time to time request information updates from policyholders, either through e-mail correspondence or mailed request forms. This information will allow the Company to customize many of its public relations and marketing materials and enable the Company to provide policyholders with a range of convenient services (e.g., automatically sending policy quotes to families with children nearing driving age, showing the rate for adding a child to their policies). The information updates also allow the Company to automatically extend personalized messages, such as congratulations on birthdays, graduations, and other special occasions.

Policyholders wishing to change coverage, amend their policies, or register a complaint or suggestion will preferably be directed to use the features available through the motor clubs, the Company's web portal or the Company's Voice Computer Interface. In one embodiment, these web sites include a virtual ‘agent’ that can address the majority of policyholders' questions online. This initiative leverages a revolutionary technology offered by Talkie, Inc. of Venice, Calif., which provides human-like digital “customer service representatives” that conduct real-time, two-way conversations with users on a highly cost-effective basis. Policyholders with unresolved requests may thereby be directed to the appropriate department or personally contacted.

Channel Partner Relations Management

Agents/Brokers, strategic marketing partners, Employer Sponsors, and other Channel Partners will preferably be provided marketing support through the online motor clubs and the Company's web portal, which they can use to access or provide third parties with access to information about the Company's products and services, process quotes in real time, and issue binders once policyholders' initial vehicle inspections are complete. Through the Company's web portal, Channel Partners may also be given immediate access to policyholder account information and claims reports (including video streams and voice data captured during initial inspections and claim estimates), as well as information about the Company's policies, underwriting guidelines, rate guides, commission reports, and new product information.

As Channel Partners join the Company's network, they may be granted access the Company's web portal where they can review a visual, informative, and interactive Web-based training program that will outline the merits and processes of the invention's system and methods of operations. A ‘Help’ tab may be available to access Frequently Asked Questions (“FAQs”) and other information that may be useful in operating the system or completing an application.

When writing policies, Channel Partners may access the Company's web portal and complete online forms that collect all of the data necessary to process insurance applications. The Company's financial management system may then electronically calculate non-binding quotes and make them available instantaneously to Agents/Brokers through the Company's web portal or other means, and prospective policyholders through the online motor clubs and/or the Company's web portal. Concurrently, the data from the online forms will be electronically organized by the Central Data Center into digital applicant files, and assigned “priority status” by the HSM system for rapid retrieval. The system will then alert the Company's Underwriting Division that there are active applicant files waiting for attention.

When the active applicant files are received, Company underwriters preferably review the data for accuracy and completeness, and the Central Data Center will access various databases to verify driving records and identify “gray market” vehicles and vehicles previously reported as salvage or total losses. If underwriters require more information, phone calls may be initiated or Web response forms exchanged with Channel Partners, thereby significantly accelerating the process of approving and issuing policies. Once all information is in hand, the IT system may calculate final quotes, and suggest one or more convenient Aligned Provider locations for initial inspections. After the initial vehicle inspections are performed, the Underwriting Division may verify the information contained in the applicant files, and issue the appropriate binders.

Channel Partners will preferably be electronically notified if any of their policyholders are late in remitting their premium payments, subject to prospective cancellation by the Company, or up for renewal.

When updates or modifications to the Company's policies, underwriting guidelines, marketing programs, or system procedures are logged in the Company's databases, Channel Partners can be digitally notified of such changes and have instantaneous access to the updated information. In addition, Channel Partners may be encouraged to voice their thoughts, make any recommendations, or propose cooperative marketing initiatives through e-mail correspondence, or by conversing with Company personnel.

Aligned Provider Relationship Management

In addition to the functionality provided by the Company's claims management and fraud prevention systems, Aligned Providers will preferably be able to monitor the status of their accounts, and have an opportunity to promote their products and services online by placing banners, links, and customized web pages on the online motor clubs. Internet-based cooperative marketing and affiliate programs may also be available.

As each Aligned Provider is added to the network, Aligned Provider staff members will preferably access the web portal and complete a visual, informative, and interactive Web-based training program that will outline the merits and processes of the invention's system and methods of operations. A ‘Help’ tab will preferably provide access to FAQ and other information that may be useful in operating the system, performing an inspection, or completing a repair estimate. Aligned Providers may also be able to confer with Company personnel via the phone, e-mail, or Web response forms.

In one embodiment, the Company further offers a suite of Web-enabled solutions and management tools to help independent “mom and pop” providers address their accounting, inventory management, billing/collections, and other operational needs. Once the Aligned Provider Network is large enough to have the clout to negotiate discounts on wholesale purchases of parts and supplies, the invention could support an Internet-based buying service for its participating providers.

Financial Functions

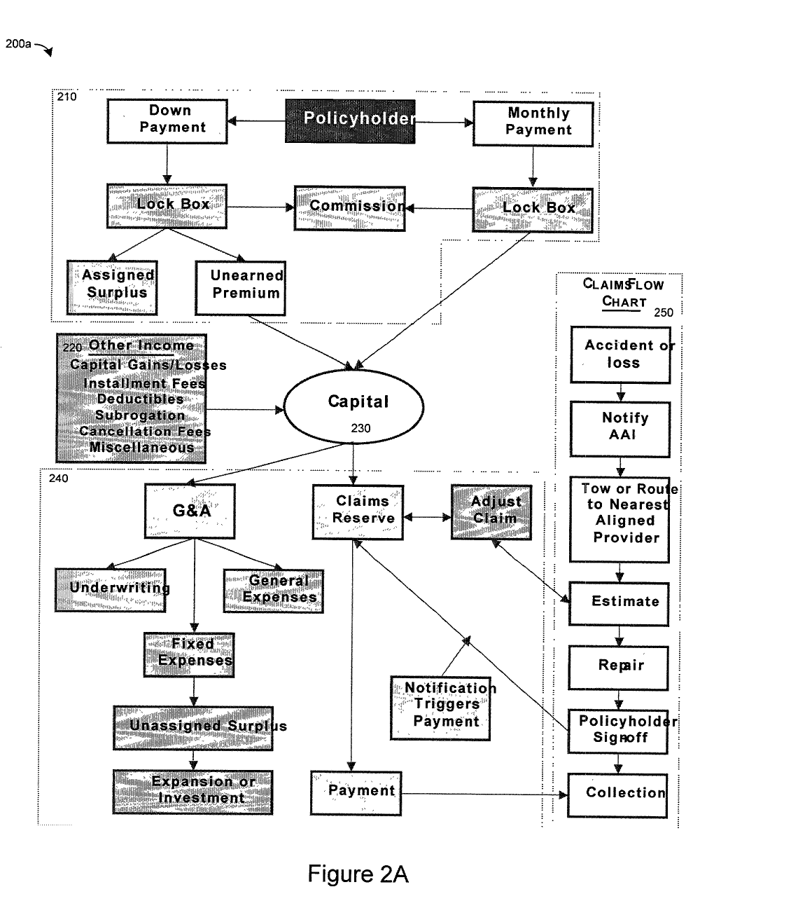

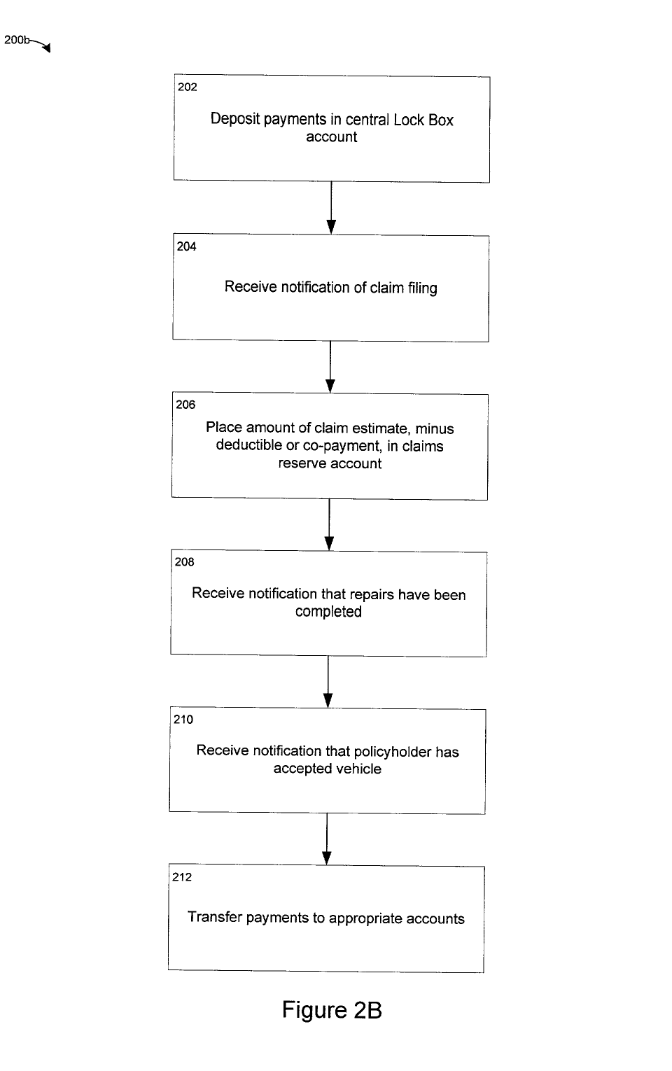

In one embodiment, the invention's financial management system digitally administers most, if not all, of the Company's risk retention and accounting functions through the use of custom software and by seamless integration with a Bank Lock Box facility provided, for example, by a banking institution. Of course, the Bank Lock Box facility could alternatively be provided internally, if desired. One embodiment of the Bank Lock Box System may be better appreciated with reference to FIGS. 2A and 2B, which illustrate a cash flow arrangement 200a and associated method 200b of the present invention.

Preferably, as illustrated in section 210, all policyholder payments, including down payments, monthly payments, etc., made to the Company, will be made to or deposited into a central Bank Lock Box account. Preferably the Bank Lock Box account will follow pre-defined instructions to automatically segregate and transfer funds into appropriate accounts (e.g., unearned premium reserve, claims reserve, assigned surplus, commission). Down payments can be processed online via an e-commerce system, through the use of check scanning devices that are preferably provided to Agents/Brokers and other strategic marketing partners, or, in the case of participating Employer Sponsors, through automatic payroll deductions. Monthly, quarterly and/or semi-annual invoices can be electronically generated and bar-coded, and billing notices can be e-mailed and mailed to appropriate parties. Policyholder payments will preferably be made electronically or mailed directly to the Company's banking partner. These payments, minus assigned surplus, along with other income 220 (e.g. capital gains, installment fees, deductibles, subrogation, cancellation fees, and others) may be placed in a working capital section 230.

As shown in The Bank Lock Box System may also incorporate the invention's AutoReserve System, which can be used for transferring an appropriate percentage of all annualized premiums electronically into an assigned reserve account upon receipt of policyholders' initial down payments. In addition, in conjunction with a claims flow process discussed below and generally illustrated in section 250, the Bank Lock Box System can provide for automatic payment of claims to Aligned Providers, as well as Out-of-Network providers, as shown in section 240.

Referring next to FIG. 2B, an embodiment of a method 200b of the present invention is illustrated. In step 202, all payments made to a company practicing the invention are preferably made to or deposited into the central Bank Lock Box account with an agent's code, policy number, and group number, where applicable. All items are preferably bar coded for constant monitoring.

In one embodiment, the bank has pre-defined instructions for how to segregate and transfer funds into the appropriate accounts. When the Company receives notification in step 204 that a claim has been filed, the full amount of the estimate, less the amount of the deductible or any required co-payment, is automatically placed into a claims reserve account in step 206. Preferably, this amount is held there until the claim is paid or denied. Typically, the company next receives notification in step 208 that repairs are completed, and in step 210 that the relevant policyholder has accepted his or her vehicle. Notification by a policyholder of vehicle acceptance may occur through various means. For example, the policyholder may log into the Company's web portal at the Aligned Provider location, inputting a password, and verify acceptance of the vehicle. Once the Company receives notification, the Bank Lock Box preferably transfers payment to the appropriate accounts, such as the Aligned Providers' business accounts, in step 212. This transfer preferably occurs electronically The invention's financial management system can be used to vastly reduce the personnel typically required to administer the financial management functions of an insurance company. In one embodiment, the system essentially replaces the need for an extensive accounting division, but also assures that a Company practicing the invention can, and will, make all of the necessary payments for commissions, claims, rebates, cancellation refunds, and other financial requirements, because these funds are protected from being used for any other purposes.

The flexibility and scalability of the invention's financial management system can allow the Company to bill directly or, if appropriate, enable its Agents/Brokers to generate and distribute invoices. Preferably, policyholders will automatically receive periodic e-mail messages and/or mailed notices providing notification if they are late in remitting their premium payments, subject to prospective cancellation, or up for renewal. As appropriate, Agents/Brokers will be electronically copied on all correspondence with policyholders. In addition, the system will handle payroll, investments, and other financial/administrative requirements.

The system can also be linked to the invention's claims management and fraud prevention systems in order to provide for automatic payment to Aligned Providers for repairs they perform. Once adjusters approve claims, the system can electronically transfer the full amounts of the estimates, less the amounts of deductibles or any required co-payments, into one or more claims reserve accounts. Once the repairs are completed and policyholders verify acceptance of their vehicles, the financial management system can electronically transfer payment to the Aligned Providers' business accounts.

The invention's financial management system can also provide highly secure electronic controls designed to assure that assets are safeguarded, transactions are properly recorded and executed, and established policies and procedures are followed. The system enables a Company practicing the invention to provide the best available form of consumer/vendor protection, and offers the benefit of the security of a major banking institution acting as fiduciary. In addition, the financial management system offers the ability to monitor policyholder accounts in real time.

The invention's financial management system can provide an effective and continuously running audit that includes the precise status of each of the Company's various accounts on a real-time basis. As a result, the Company's financial condition can be monitored 24 hours a day, seven days a week.

Risk Retention

One aspect of the invention includes an AutoReserve feature, which can be used to greatly enhance the safety of the policyholder. The Company's risk retention levels can be greatly enhanced by the use of this unique front-end, self-reserving mechanism that guarantees the financial safety of the Company, its policyholders, and Aligned Providers. The system will preferably require that an appropriate percentage of all gross annualized premiums is electronically transferred into an assigned surplus account, an amount that preferably comes out of the initial down payments from policyholders, enabling the Company to continually maintain an optimal Reserve Ratio at all times, regardless of the pace at which the Company's policyholder base grows.

This method, in conjunction with the Company's preferred internal policy to not rely on unassigned surplus to cover its unearned premium, can protect the Company and its policyholders as it allows the Company to shut down on any given day without any risks in fully satisfying pending claims, claims incurred during the 60 days after the Company gives notice of its intent to shut down, and unearned premium refunds due. The Company has, in effect, developed a system that assures payment and financial viability, and protects the Company, its policyholders, and Aligned Providers.

Preferably, once claims are approved, the Bank Lock Box will preferably electronically transfer the full amounts of the estimates, less the amounts of any deductibles or required co-payments, to a claims reserve account, where the funds can be held until claims are paid or denied. A second claims Reserve Account, designed to reflect estimates of claims that have been incurred but not yet reported, may also be established. In addition, since Aligned Providers will preferably be required to warrant their workmanship and maintain appropriate indemnity coverage, the Company's risks stemming from improper repairs will be mitigated.

The invention's AutoReserve System is unique to the insurance industry. It preferably provides enhanced risk coverage, a more accurate financial picture, and the ability to support unlimited growth without continually raising additional reserve capital. In one embodiment, the system includes real-time warning methods for any potential financial issues. The warnings can be triggered long before these issues can evolve into major problems—a considerable advantage over traditional risk management procedures.

Anti-fraud Plan

Automobile insurance fraud represents one of the insurance industry's greatest challenges and is responsible in large part for a tense and tenuous relationship between many insurers and the public. The National Auto Theft Bureau estimates that 15% of all vehicle theft reports are fraudulent. Auto insurance fraud is the largest and fastest growing segment of insurance fraud, and the cost of all fraudulent automobile claims account for 15 to 20% of auto insurance premiums (or 25 to 33% of total claims expenditures).

The invention's mandatory automobile inspection program minimizes a claimant's ability to inflate the value of lost or damaged property or attempt to collect for damage that existed prior to an insurance binder being issued. The Company may maximize the use of digital records of vehicle inspection by requiring that, prior to accepting insurance applications, prospective policyholder vehicles are inspected by trained Aligned Provider service inspectors, who carefully examine the vehicle's documentation, identification numbers, overall condition, and optional equipment, and record the findings on an electronic inspection report that includes full motion digital videos of the vehicle (including close-ups of any prior damage, and a voice commentary). The vehicle inspection program provides an accurate record of “what is,” which may not necessarily be what the policyholder claims.

By giving its Aligned Providers a substantial volume of business (and actively promoting their products and services), the system provides the Aligned Providers with the motivation to process claims in a fair and professional manner. This, coupled with the invention's automobile inspection program and technology-driven claims adjusting system, is valuable in preventing many types of fraud, including claims for non-existent or “phantom” repairs and claims for damage incurred prior to the issuance of a binder.

The combination of a sophisticated operating structure with a leading-edge information system creates the most effective fraud prevention system currently available in the automobile insurance industry. These features of the invention will significantly reduce direct claims expenses, which ensures a loss ratio that will be one of the lowest, perhaps even the lowest by far, in the insurance industry.

Other key components of the invention's fraud control program include:

Lock Box Security. The Bank Lock Box facility provides a system of electronic controls designed to assure that assets are safeguarded, that transactions are properly recorded and executed, and that established Company policies and procedures are followed. An additional level of security may also be added by using a major banking institution as fiduciary if desired.

Special Investigation Units. Special investigation units may be used as an element of the invention's integrated fraud control program to perform activity checks, conduct on-site visits, take depositions, investigate suspected complex or unusual fraud that requires specialized expertise, and other fraud prevention initiatives (e.g., maintaining up-to-date information on new fraud scams, suspected rings, related legal issues and current investigation techniques).

Technology Infrastructure and Applications

Established insurance companies are devoting a majority of their IT resources to aligning “internalized” legacy infrastructures with the customer-centric e-business models demanded by today's market. The invention preferably uses a truly “open” system architecture and proven leading-edge technologies to ensure that the Company realizes significant competitive advantages, provides exceptional customer value and service and maximizes the value derived from its knowledge and technology assets.

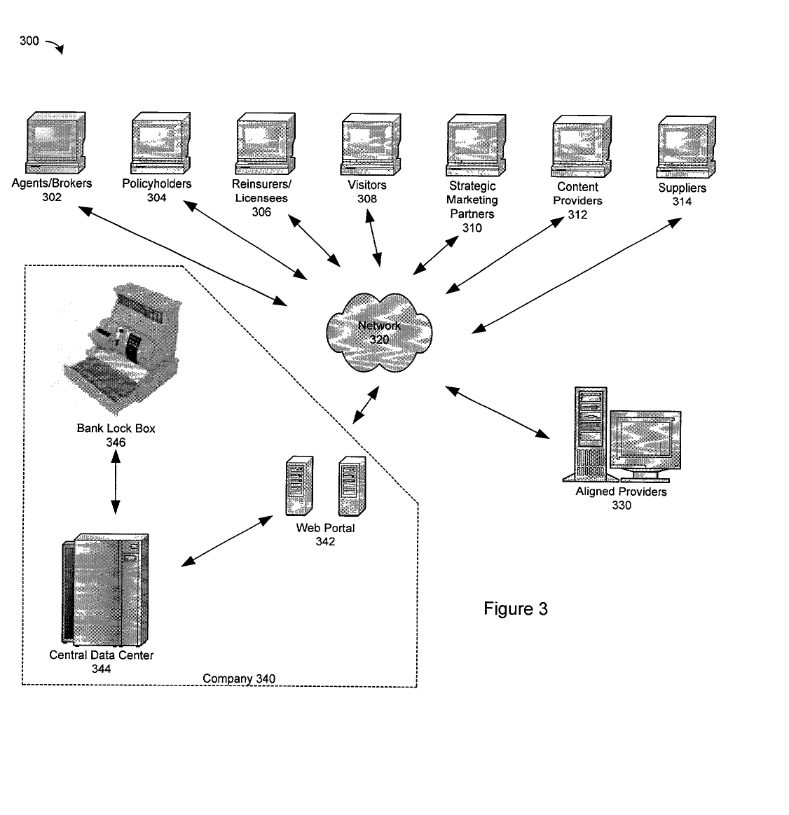

Referring to FIG. 3, and exemplary IT system 300 of the present invention is illustrated. As shown, the system 300 may include systems of such entities as agents/brokers 302, policyholders 304, re-insurers/licensees 306, visitors 308, strategic marketing partners 310, content providers 312, suppliers 314, etc. The system 300 also includes one or more, and preferably a network of, Aligned Providers 330. Each of these above entities is preferably in communication with the Company 340 through the Company's web portal 342 via a network 320. The web portal 342 preferably includes one or more web servers and appropriate storage. As discussed throughout, the Company 340 further includes a Central Data Center 344 and a Bank Lock Box 346. It is also contemplated that the Company further include any or all of the other entities of the system 300, or others. For example, the Aligned Providers 330 may be internal Company employees, groups, organizations, etc. In one embodiment, the IT system 300 allows a company practicing the invention to perform any or all of the following:

Process claims from the home office (or any other location) without having to send claims adjusters to repair sites;

Institute the most effective fraud prevention system currently available in the automobile insurance industry;

Maintain a 24-hour audit trail of all accounting functions without the need for an extensive accounting division;

Employ a user-friendly interface for underwriting and marketing support, as well as enhanced communication with its prospects, policyholders, Aligned Providers, Agents/Brokers, Strategic Partners, and Employer Sponsors; and

Provide compelling, high impact, consumer-oriented online environments.

In a preferred embodiment, the invention is comprised of the following components:

Primary and backup server clusters that combine the full functionality of symmetrical multi-processing in a highly-available configuration, and provide near 100% availability at all times;

A high-speed secure data link to the Bank Lock Box facilities;

Seamless digital video/audio streaming and storage;

High-resolution, high-capacity digital video camcorders for the input, storage, and transport of video and voice;

Document scanning devices and optical character recognition (“OCR”) software for forms management and workflow;

A Hierarchical Data Storage (“HSM”) system for the organization, storage, and archiving of an unlimited amount of video, voice, and electronic forms data; and

An emerging Customer Relationship Management (“CRM”) integration model leveraging several leading-edge telephony applications (e.g., Touchtone Order Entry System, Interactive Voice Response System, Wireless Application Protocol).

As will be appreciated by one skilled in the art, however, fewer or additional features may be a part of the present invention as well.

System Architecture

In practicing the invention, the Company's architectural objective is preferably to build its IT infrastructure in the most cost effective and time efficient way possible. In order to achieve this objective, the system architecture will preferably provide:

Linear Scalability, which allows for continuous growth to meet user demands and business complexity;

Continuous Availability that provides redundancy and functional specialization to contain faults;

Data and Infrastructure Security to protect the IT system and data from attack, disaster, or theft; and

Ease of Management, ensuring that operations can match growth.

Linear Scalability

To scale, a Company practicing the invention will preferably use a multi-tiered architecture, including front-end (client-accessible) systems, data process servers that are each optimized for a particular task, and back-end systems where long-term persistent data are stored or where business-processing systems are located. Load balancing will preferably be used to distribute the work across systems at each tier. This architecture can quickly scale to meet increasing numbers of unique users supported by addition of stateless, load-balanced front-end systems and clustering data processing and back-end systems.

By partitioning its online content across multiple specialized systems, the Company can scale, while the load-balancing system routes requests to the correct data processing or back-end systems. Specific servers are preferably dedicated to task-specific services, including integration with partner legacy or offline systems. Cloning and partitioning can offer the Company's systems an exceptional degree of scalability by growing each service independently and only as needed.

Availability

In a preferred embodiment, the IT system has the ability to store vast amounts of information and retain that information online or near-line for long periods of time via the central hierarchical storage management system. This central hierarchical storage management system can provide instantaneous access to information about new accounts and active claims, and fast access to archived or historical information. Storing information in this way allows the Company to reduce the amounts and costs of warehousing space typically required to maintain volumes of paper files, which is a major concern for any insurance company. Preferably, the Company will store back-up files on compact media at an offsite location, which helps to eliminate risks associated with theft, fire, power outages, or other types of disasters. In general, the invention's IT system is designed to be the safest and most effective in the insurance industry.

Preferably, the invention's front-end systems will be made highly available and scalable through the use of multiple cloned servers (while providing a single address to clients) and load balancing (for distributing loads across the clones). A clone that is no longer offering a service will be automatically removed from the load-balance set, while the remaining clones continue to offer the service. Specialized systems are preferably made highly available by using failover and parallel server clustering for each partition.

Failover clustering can create an environment in which an application can resume on another computer that has been given access to the failed systems disk subsystem. Preferably, the service failover is triggered when the primary node supporting requests to the partition fails and requests to the data service fails, whereby the takeover node configures itself to answer requests. The takeover node(s) preferably have access to the same data storage system, which will also be replicated for an additional level of availability.

Security

Preferably, the Company will employ security covering three primary activity domains. Each domain can by protected by a network filter, virtual private network, or firewall. The three activity domains may include:

The Internet or public network;

The DMZ (adopted from the military term De-Militarized Zone), where front ends and non-confidential content servers are placed; and

The invention's secure network, where content is created or staged and secure data is managed and stored.

In addition to compact media back-ups, all corporate data will preferably be replicated to a Backup Data Center in a geographically different location so that any interruption of service from the Central Data Center will not generate a long-term service outage. Use of a mirror site makes it feasible to restore all services in under one hour during disaster situations at the Central Data Center, such as earthquakes, electrical power failures, fires, or floods.

Systems Management

In one embodiment of the invention, the Company will maintain its Central Data Center at an Internet collocation center that will provide systems management, high-speed network access, telephone access for the Voice Computer Interface, redundant power sources, and other world-class data center amenities. Accordingly, the management and monitoring of the invention's IT systems can be done remotely in conjunction with the chosen collocation facility and/or IT management company.

Claims Management and Fraud Prevention Systems

The web portal provides a secure, digital, paperless environment for processing claims and preventing fraud. The portal administers the claims management and fraud prevention systems of a company practicing the invention by capitalizing on state-of-the-art internet-based technologies to simplify the claim estimating and adjusting processes, and to minimize fraud.

In a preferred embodiment of the invention, a company practicing the invention supplies each of its Aligned Providers with a computer system comprising:

A minimally configured high performance workstation,

A digital video camcorder, and

A high-speed secure Internet connection (i.e., DSL or Cable Modem).

Upon the acceptance of policyholder applications, a company practicing the invention may require that all policyholders (with the possible exception of new car buyers) have their vehicles professionally inspected by Aligned Provider service attendants. During the initial inspections, service attendants may perform analyses and take full motion videos of the vehicles. Preferably, attendants will also provide voice commentary regarding any pre-existing damage or other relevant matters.

In a preferred embodiment of the invention, video and voice data are transmitted via high-speed internet connections to the Company's Central Data Center; additional information may also be inputted by Aligned Providers into forms that can be accessed via the web portal. The video, voice, and form data are then electronically organized into digital policyholder files, reviewed by the Company's adjustment office for accuracy and completeness, and permanently stored in the Company's Hierarchical Storage Management System.

In the event of an accident, a policyholder notifies the Company by calling a claim Hotline and conferring with a Voice Computer Interface (or speaking with a live person), or by using one of the Company's online motor clubs. Policyholders may be directed to the nearest Aligned Provider locations (or tow trucks will be dispatched). Policyholders may also notify the Company of an accident via a web portal or third party extranets that can automatically direct the policyholders to the nearest Aligned Provider locations (or electronically dispatch tow trucks). In any case, the appropriate Aligned Providers will be digitally notified of the impending arrivals of damaged vehicles. Meanwhile, the Central Data Center will preferably create digital claim files, update digital policyholder files, and automatically notify the claims Division that active claim files require attention. In addition, the Hierarchical Storage Management System may shift applicable digital policyholder files to priority status for rapid retrieval.

Once damaged vehicles arrive at the Aligned Provider locations, Aligned Provider service attendants may access the web portal, input a security code, and view data relevant to the claims (including the video streams and voice commentary captured during initial inspections). Numerous video streams or single frames can be instantaneously displayed on the Aligned Providers' web browsers, which ensures that video coverage of every vehicle is complete. Consequently, service attendants will be aware of any pre-existing damage prior to initiating the claim estimates.

Following the review of the initial inspection data, service attendants may perform inspections of the damaged vehicles, take full motion videos of the vehicles, and provide voice commentary regarding the relevant damage. Aligned Providers then access the web portal, electronically transmit the new video and voice data, and access a series of web forms comprising all of the data required to complete a repair estimate. Aligned Providers may complete the forms online, detailing the losses and providing all necessary information. The Central Data Center immediately integrates the video, voice and web form data into appropriate digital policyholder files, and alerts the Company's claims adjustment office that active claim files require attention.

Preferably, upon receipt of the active claim files, adjusters review the video and voice data (of both the initial inspections and damaged vehicles), as well as the web form data, to immediately confirm the damage, and make certain that no pre-existing damage was included in the estimates. If claims adjusters require more information, they can initiate phone calls or send Web request forms, which can significantly accelerate the process of approving repair estimates. In addition, the invention's Central Data Center automatically calculates the most current prices for parts and labor in accordance with the Company's agreements with its Aligned Providers.

Once the adjustment office approves the claims, Aligned Providers can commence repairs and the Bank Lock Box digitally transfers the appropriate amounts to a claims reserve account. Once the repairs are completed and the policyholders have accepted their vehicles (by logging into the web portal at the Aligned Provider locations, inputting their passwords, and verifying their acceptance of the vehicles), the Bank Lock Box electronically transfers payment to the Aligned Providers' business accounts.

The invention's claims management and fraud prevention systems:

Help control fraud by preventing the inclusion in repair estimates of damage incurred prior to the issuance of insurance policies;

Enhance policyholder satisfaction by expediting the claims approval process; and

Reduce the costs associated with adjusting claims (video-enabled adjusters will be able to service up to ten or more claims per day; traditional field adjusters can typically service up to four per day).

Financial Management System

The invention's financial management system coordinates the processing of all risk retention and accounting functions through the application of custom software and seamless integration with the Bank Lock Box system, which may be provided internally or by an external banking institution, for example. The invention's use of lock box technology is unique to the insurance industry, and is expected to vastly reduce the amount of personnel typically required to administer accounting and billing/collection functions. This technology may essentially eliminate the need for an extensive accounting division, while also assuring that the Company can make all of the necessary payments of commissions, claims, rebates, cancellation refunds, and other financial requirements. The system will provide enhanced risk coverage, a more accurate financial picture, and the ability to support unlimited growth without the need to continually raise additional reserve capital. In addition, the system will effectively provide a running audit, including the status of the various accounts on a continual 24 hours a day, 7 days a week, year-round basis. As a result, the financial condition of the Company and any of its subsidiaries can be derived and monitored at any point in time.

Preferably, all payments made to a company practicing the invention are made to or deposited into the central Bank Lock Box account with an agent's code, policy number, and group number, where applicable. All items may be bar coded for constant monitoring, and automatically segregated into appropriate accounts (e.g., assigned surplus, unearned premium reserve, claims reserve, working capital) by pre-defined instructions. This process incorporates the invention's AutoReserve System, whereby an appropriate percentage of all annualized premiums will be electronically transferred into an assigned reserve account upon receipt of policyholders' initial down payments. Down payments may be processed online via an e-commerce system through the use of check scanning devices that will be provided to Agents/Brokers or other partners. In a case of Employee Benefits, the payments may be via payroll deduction. Monthly, quarterly and/or semi-annual invoices may be electronically generated and bar-coded, and billing notices may be e-mailed and/or mailed to appropriate parties. Policyholder payments may be made electronically or mailed directly to the Company's banking partner. The AutoReserve System provides enhanced risk coverage, a more accurate financial picture, and the ability to support unlimited growth without continually raising additional reserve capital.

The invention's financial management system maintains digital underwriting profiles of policyholders and other drivers in order to accurately and fairly calculate the risk of insuring properly identified vehicles. The system also maintains comprehensive data files comprised of coverage information, unacceptable risks, policy issuance procedures, rating procedures, and general underwriting rules in order to instantaneously and accurately calculate quotes. The system preferably also accesses various databases to verify driving records and identify “gray market” vehicles and vehicles previously reported as salvage or total losses.

By accessing the web portal and inputting a password, Agents/Brokers are able to review the Company's general underwriting rules and guidelines, including an electronic rate guide defining territorial limits, classes of automobile users, driver discounts and surcharges, automobile body types, policyholder rating codes, geographic operating zones for Aligned Provider coverage, and other relevant information.

In one embodiment, the financial management system also handles receipts of electronic premium payments/payroll deductions from policyholder bank accounts/employers, as well as the payroll, investments, and other financial/administrative needs. These accounts may be updated at any given minute, daily, etc., depending upon the capabilities of the bank's current transaction processing systems. All policyholder and other third-party invoices will be electronically generated, and respective billing notices will be e-mailed to appropriate parties and printed for direct mail purposes. In addition, the system may electronically notify Agents/Brokers if any of their policyholders are late in remitting their premium payments or subject to possible cancellation of coverage.

As mentioned previously, the invention's financial management system provides for automatic payment of claims to the Aligned Providers. Preferably, once the adjustment office approves the claims, the Bank Lock Box electronically transfers the appropriate amounts to a claims reserve account. Once the repairs are completed and policyholders verify acceptance of their vehicles, the Bank Lock Box electronically transfers payment to the Aligned Providers' business accounts.

The flexibility and scalability of the Company's financial management system allows the Company to bill directly or, if appropriate, enable its Agents/Brokers to generate and distribute invoices. Policyholders may automatically receive periodic email messages and/or mailed notices providing notification if they are late in remitting their premium payments, subject to prospective cancellation, or up for renewal. As appropriate, Agents/Brokers may be electronically copied on all correspondence with policyholders. In addition, the system may handle payroll, investments, and other financial/administrative requirements.

In one embodiment, the system is also linked to the Company's claims management and fraud prevention systems in order to provide for automatic payment to Aligned Providers for repairs they perform. Once adjusters approve claims, the system is able to electronically transfer the full amounts of the estimates, less the amounts of deductibles or any required co-payments, into one or more claims reserve accounts. Once the repairs are completed and policyholders verify acceptance of their vehicles, the financial management system may electronically transfer payment to the Aligned Providers' business accounts.

The Company's financial management system provides highly secure electronic controls designed to assure that assets are safeguarded, transactions are properly recorded and executed, and established policies and procedures are followed. The system provides the best available form of consumer/vendor protection, and offers the benefit of the security of a major banking institution acting as fiduciary. In addition, the financial management system offers the ability to monitor policyholder accounts in real time.

The Relationship Management System

The online market demand for complete relationship management is driving the integration of Web, telephony, and database technologies. In one embodiment, the invention addresses this challenge by creating a coordinated relationship management system (“RMS”) that captures Web and Call Center contact or “touch point” data, delivers it to the back office systems for analysis and dimensional presentation, and returns the results, in real time, to the policyholder or channel partner profiles, where it is available across all delivery channels and points of contact via the Web, policyholder relations personnel, Agents/Brokers, and others. This will enable a Company practicing the invention to efficiently convert prospect or policyholder service inquiries into sales, and provide unparalleled customer service.

Preferably, the Company will integrate any or all of the following three technologies in developing its RMS infrastructure:

Computer Telephony Integration (“CTI”). CTI can allow the Company to apply consistent business logic to manage incoming calls. Real-time information about callers is captured and linked with customer information from the Company's various data repositories. The information will then be used to better address the callers' needs.

Data Warehousing. In the invention's Data Warehouse, information from the CTI and Web interfaces is preferably broken down from a transactional structure to a de-normalized structure better suited to multidimensional and trend analysis.

Decision Support. The invention's Decision Support System will preferably use sophisticated algorithms to assist the Company in making clear decisions about specific customer needs.

In one embodiment, the invention's RMS is comprised of three components: Policyholder Relations Management, Channel Partner Relations Management, and Aligned Provider Relations Management. Each of these functions can be enhanced through the integration of highly advanced RMS systems and components that, among other benefits, enable prospects, policyholders, providers, and partners to communicate with the Company via multiple touch points, including the Internet, e-mail, telephone, wireless devices, and direct mail.

Policyholder Relations Management

In one embodiment, to reduce the need for policyholders to contact their Agents/Brokers or the Company's Policyholder Relations Division, policyholders are given automated 24-hour access to their policies and other account information through a web portal, or by calling the Company's Policyholder Support Line and accessing the Voice Computer Interface. The interface preferably integrates several leading-edge telephony applications, including a customized Touchtone Order Entry System, Interactive Voice Response System, Wireless Application Protocol, seamless integration with the invention's databases, and a voice-mail system that will store messages for later retrieval by telephone or online through the Company's intranet. A web portal can also provide access to policy and other Company information, although it will not include the non-insurance content and benefits offered by the online motor clubs.

When policyholders access the web portal or online motor clubs using their personally selected or Company-assigned passwords, they can be given access to a range of services and information about their accounts, including the types of coverage in effect, billing data, status of active claims, and a claims reporting system. The claims reporting system preferably automatically notifies the Company's Claims Division of accidents or losses and routes policyholders to the most convenient Aligned Provider locations or, if necessary, automatically has tow trucks dispatched. In one embodiment, as Internet-based video conferencing becomes more reliable, policyholders will be able to conduct real-time, interactive two-way conferences with their Agents/Brokers, Aligned Providers, and/or Company personnel.

Preferably, policyholders will receive periodic e-mail messages providing updates on their accounts or policies, including notification if they are late in remitting their premium payments, subject to prospective cancellation, or up for renewal. Policyholders may also receive news about products and services offered by Aligned Providers and Strategic Partners, as well as special promotions and information about the automobile and insurance industries, such as new product information, regulatory initiatives, and other valuable content.

Preferably, the invention's IT system will include a constantly updated database of policyholder and Website visitor/member profiles to enable the Company to respond to the demands and desires of its most valuable commodity—its customers. The IT system can automatically generate periodic requests for information updates to keep all policyholder and visitor/member files current. This information can be requested automatically at the time policyholders or visitors/members log on to the web portal or online motor clubs, or through mailed request forms. The information will preferably allow a company practicing the invention to customize many of its public relations and marketing materials to provide policyholders with a range of benefits. The information also allows the Company to automatically extend personalized social messages on special occasions, such as birthdays.

Channel Partner Relations Management

In one embodiment, Agents/Brokers, strategic marketing partners, Employer Sponsors, and other Channel Partners are provided with marketing support through the web portal or online motor clubs, which they can use to access information about the Company's products and services, process quotes in real time, and issue binders once policyholders' initial vehicle inspections are complete. Through a web portal, Channel Partners can also have immediate access to policyholder account information and claims reports (including video streams and voice data captured during initial inspections and claim estimates), as well as information about Company policies, underwriting guidelines, rate guides, commission reports, and new product information.

As Channel Partners join the Company's network, they will preferably be able to access a web portal complete a visual, informative, and interactive Web-based training program that will outline the merits and processes of the invention's IT system and methods of operations. A ‘Help’ tab may be available to access Frequently Asked Questions (“FAQs”) and other information that may be useful in operating the system or completing an application.

When writing policies, Channel Partners will preferably access a web portal and complete online forms that collect all of the data necessary to process insurance applications. The invention's financial management system can then electronically calculate non-binding quotes and make them available instantaneously to Agents/Brokers through a web portal and prospective policyholders through a web portal or online motor clubs. Concurrently, the data from the online forms will preferably be digitally organized by the Central Data Center into digital applicant files, and assigned “priority status” by the HSM system for rapid retrieval. The system can then alert the Company's Underwriting Division that there are active applicant files waiting for attention.

When the active applicant files are received, underwriters will preferably review the data for accuracy and completeness, and the Central Data Center will access various databases to verify driving records and identify “gray market” vehicles and vehicles previously reported as salvage or total losses. If underwriters require more information, phone calls may be initiated or Web response forms exchanged with Channel Partners, which can significantly accelerate the process of approving and issuing policies. Once all information is in hand, the IT system will calculate final quotes, and suggest one or more convenient Aligned Provider locations for initial inspections. After the initial vehicle inspections are performed, the Underwriting Division will preferably verify the information contained in the applicant files, and issue the appropriate binders. Preferably, Channel Partners will be electronically notified if any of their policyholders are late in remitting their premium payments, subject to prospective cancellation, or up for renewal. When updates or modifications to the Company's policies, underwriting guidelines, marketing programs, or system procedures are logged in the Company's databases, Channel Partners can be digitally notified of such changes and have instantaneous access to the updated information.

Aligned Provider Relationship Management

In addition to the functionality provided by the invention's claims management and fraud prevention systems, Aligned Providers will preferably be able to monitor the status of their accounts, and have an opportunity to promote their products and services online by placing banners, links, and customized web pages on the online motor clubs. Internet-based cooperative marketing and affiliate programs may also be made available.

As each Aligned Provider is added to the network, Aligned Provider staff members will preferably access a web portal and complete a visual, informative, and interactive Web-based training program that will outline the merits and processes of the invention's system and methods of operations. A ‘Help’ tab can be used to provide access to FAQ and other information that may be useful in operating the system, performing an inspection, or completing a repair estimate. Aligned Providers will preferably also be able to confer with Company personnel via the phone, e-mail, or Web response forms.

In one embodiment, a company practicing the invention could eventually offer a suite of Web-enabled solutions and management tools to help independent “mom and pop” providers address their accounting, inventory management, billing/collections, and other operational needs. Once the Aligned Provider Network is large enough to have the clout to negotiate discounts on wholesale purchases of parts and supplies, the Company could institute an Internet-based buying service for its participating providers.

### CONCLUSION

The operating system and other features of the present invention are designed to make the Company the most efficient operator in the insurance industry. By taking full advantage of highly advanced digital video, data management, and online technologies, the Company's operating system can reduce the substantial number of employees found at most insurance companies today to a streamlined staff of executives, specialists, and support personnel. Aligned Providers preferably handle the primary functions of claims; most financial controls are preferably managed by integrating the information technology system and the Bank Lock Box; and the effectiveness of policyholder relations activities can be enhanced and related costs reduced through the capabilities of a specialized web portal. The fraud prevention system, claims management system, financial management system (including, among other procedures, the AutoReserve system), and information technology platform aspects of the invention can be used together to produce significant efficiencies and cost savings over current systems and methods.

While various embodiments of the present invention have been described above, it should be understood that they have been presented by way of example only, and not limitation. Thus, the breadth and scope of the present invention should not be limited by any of the above-described exemplary embodiments, but instead, only by the scope of the appended claims and their equivalents.

What is claimed is:

1. A system for insurance management, comprising:
a central data center;
an insurer portion, coupled to said central data center via a network, for interfacing an insurer with insurance policy and policyholder information;
a policyholder portion, coupled to said central data center via the network, for interfacing a policyholder or potential policyholder with insurance policy information; and
an aligned provider portion, coupled to said central data center via the network, for interfacing an aligned provider with policyholder and insurance claims information;
wherein said insurer portion, said policyholder portion and said aligned provider portion are enabled for real-time intercommunication and information access via the network.

2. The system of claim 1, wherein said aligned provider portion is enabled for management of vehicle maintenance information, said aligned provider portion further comprising:
a video interface for capturing full-motion digital video of a vehicle during an initial inspection or a damage inspection.

3. The system of claim 2, wherein said aligned provider portion is further enabled for collection of a deductible from the policyholder.

4. The system of claim 1, wherein said central data center and said agent portion are physically located at a common location.

5. The system of claim 1, wherein said insurer portion is enabled for automatically assessing risk of a potential policyholder, said insurer portion further comprising:
an underwriting portion for calculating a risk of insuring identified vehicles; and

6. The system of claim 5, said insurer portion further comprising:
data files, coupled to said underwriting portion, for storing coverage information, risk acceptability information, policy issuance procedures, rating procedures, and general underwriting rules;
wherein said underwriting portion is enabled for providing an instantaneous rate quote based on information provided by the potential policyholder and the information stored by said data files.

7. The system of claim 6, said insurer portion further comprising:
a potential policyholder interface for providing to a potential policyholder access to said underwriting portion.

8. The system of claim 7, said potential policyholder interface comprising:
a touch-tone telephone interface for enabling the potential policyholder to obtain the instantaneous rate quote via touch-tone telephone.

9. The system of claim 1, further comprising:
a financial management portion, coupled to said central data center, for performing accounting functions for said system.

10. The system of claim 9, said financial management portion further comprising:
a lock box facility enabled for automatically allocating funds to an appropriate account;
wherein the lock box facility is further enabled for maintenance of a record of the allocating as part of a record of transactions.

11. The system of claim 10, wherein said lock box facility is enabled for allocation of funds into at least one of an unearned premium reserve account, a claims reserve account and a working capital account.

12. The system of claim 11, said lock box facility further comprising:
an autoreserve system enabled for automatically transferring a percentage of annualized premiums to appropriate statutory reserve accounts upon receipt of funds from a policyholder.

13. The system of claim 9, said financial management portion further comprising:
an audit portion for continually monitoring a status of accounts of the system.

14. The system of claim 1, further comprising:
a strategic partner portion.

15. The system of claim 14, said strategic partner portion comprising:
an automobile dealership coupled to the network.

16. The system of claim 14, said strategic partner portion comprising:
a financing company coupled to the network.

17. A method for insurance claims management by a Company, comprising:
granting, to a policyholder or potential policyholder, network access to insurance policy information of the Company;
granting, to an aligned provider, network access to policyholder and insurance claims information of a policyholder of the Company;
enabling the policyholder or potential policyholder, the Company and the aligned provider for intercommunication via the network; and
granting the policyholder or potential policyholder and the aligned provider real-time access to the information of the Company via the network.

18. The method of claim 17, further comprising:
offering a policy to the potential policy holder at a reduced rate in exchange for an agreement by the potential policy holder to use the aligned provider in the event repair services are needed

19. The method of claim 17, further comprising:
designating a repair facility as an aligned provider.

20. The method of claim 19, further comprising:
requiring an increased deductible from the policyholder or potential policyholder when the policyholder or potential policyholder elects to use a repair facility that has not been designated as an aligned provider.

21. The method of claim 17, further comprising:
offering an insurance policy to any potential policy holder at a reduced rate in exchange for an agreement by the potential policy holder to use the aligned provider in the event repair services are needed.

22. The method of claim 17, further comprising:
automatically assessing a risk of insuring an identified vehicle from a data file for a corresponding policyholder or potential policyholder; and
underwriting an insurance policy for the corresponding policyholder based on said assessing.

23. The method of claim 22, further comprising:
reassessing an assessed risk of insuring a damaged vehicle when a policyholder elects to have a damaged vehicle repaired under the policyholder's insurance policy; and maintaining the assessed risk of insuring the damaged vehicle when the policyholder elects a self-repair option.

24. The method of claim 22, wherein the data file includes coverage information, risk acceptability information, policy issuance procedures, rating procedures, and general underwriting rules, the method further comprising:
providing a real-time insurance rate quote based on the data file.

25. The method of claim 24, further comprising:
by a touch-tone telephone interface, enabling the potential policyholder to obtain the instantaneous rate quote via touch-tone telephone.

26. The method of claim 17, wherein the Company manages vehicle maintenance information, the method further comprising:
receiving from the aligned provider full-motion digital video of a vehicle via a video interface during an initial inspection or a damage inspection of the vehicle.

27. The method of claim 17, wherein the Company manages vehicle maintenance information, the method further comprising:
delivering to the aligned provider full-motion digital video of a vehicle's initial inspection via a video interface for review prior to performing a damage inspection of the vehicle.

28. The method of claim 17, further comprising:
automatically allocating received funds, via a lock box facility, to an appropriate account; and
maintaining, via the lock box facility, a record of said allocating as part of a record of transactions.

29. The method of claim 28, further comprising:
allocating funds, via the lock box facility, into at least one of an unearned premium reserve account, a claims reserve account and a working capital account.

30. The method of claim 29, further comprising:
automatically transferring, via the lock box facility, a percentage of annualized premiums to appropriate accounts upon receipt of funds from a policyholder.
